(19) United States
(12) Patent Application Publication
(10) Pub. No.: US 2009/0265623 A1
(43) Pub. Date: Oct. 22, 2009

(54) CUSTOMIZING CALENDAR VIEWS

(76) Inventors: Nancy E. Kho, Belmont, MA (US); Henry Y. Wong, San Jose, CA (US)

Correspondence Address: HOFFMAN WARNICK LLC, 75 STATE STREET, 14TH FLOOR, ALBANY, NY, 12207, US

(21) Appl. No.: 12/104,540

(22) Filed: Apr. 17, 2008

(51) Int. Cl. G06F 17/00

(52) U.S. Cl. 715/273

(57) ABSTRACT

The present solution provides a system for users to create public and/or personal custom tags, apply them to calendar events, and then view calendar events based on various combinations of tags. Users can manually apply either preexisting or newly created tags to individual (or repeating) calendar events or they can create filters to automatically apply tags to meetings. Filters may used to apply tags to events in an individual's personal calendar, or they may be used to apply public, system-wide tags to calendar events being sent to a list of participants. Filters can be created to apply tags to a meetings based on a various attributes of the meeting, such as keywords in either the subject or meeting text, the meeting chair, the number of attendees, whether or not the user is required to attend, etc.

### FIELD OF THE INVENTION

The present invention generally relates to customizing calendar views. Specifically, the present invention relates to the customization of calendar views via public and/or personal tags and filters.

### BACKGROUND OF THE INVENTION

Many people use calendar software to track their meetings, appointments and day-to-day activities. However, a user's calendar is often filled with many events and the user may not want to view all of the events at once. For example, when a user wants to look ahead and plan/prioritize events, some events may be unimportant, may conflict with each other, or may not require the user's attendance. The user may only be interested in a certain topic or set of activities. For example, a user may only be concerned with work related events and not personal events, or a user may only be interested in meetings related to a certain project or team. With current calendar and scheduling software, it can be difficult to sort through all the information presented and find only the meetings that the user is concerned with.

### SUMMARY OF THE INVENTION

Under the present solution, a user may apply a public tag to an event; this tag may be seen and user by all other participants. For example, a user who is the creator of a calendar event may create a public tag for the event. Second, in addition to manually applying public and/or personal tags to events, a user may also create and apply one or more tags to new events, including outgoing and incoming events, or already existing events automatically through filters. The use of filters to automatically tag events decreases the amount of work the user must do. For example, the user may set a filter to automatically tag all one-on-one meetings and for all meetings in which he or she is the chair as “high priority.” As another example, an organizer for company events may create a filter to tag events sent to the entire company as “Company-wide” and this public tag could then be used by all participants. The filters may be set up by the user or a group to which the user belongs (e.g., his or her team or company). Third, the user may filter the calendar view based on various combinations of tags. This allows the user to view only the events that meet certain criteria. For example, the user might tag certain events as “low priority” and then only display events that either have or have not been tagged as “low priority.” In another scenario, the user might want to see all the meetings that either has been tagged with a particular project name or as “one-on-one” meetings. Alternatively, the user may want to see only meetings chaired by a particular person that were also tagged as “high priority.” This system allows the user to quickly set up filters to apply tags, as well as to manually tag individual events, and provides a mechanism through the user interface to display only those meetings that the user wants to see.

A first aspect of the present invention provides a method for customizing calendar views, comprising: applying a set of public tags to the set of calendar events according to the set of filters; and generating a calendar view based on the set of public tags.

A second aspect of the present invention provides a system for customizing calendar views, comprising: a module for applying a set of public tags to the set of calendar events according to the set of filters; and a module for generating a calendar view based on the set of public tags.

A third aspect of the present invention, program product stored on a computer readable medium for customizing calendar views, the computer readable medium comprising program code for causing a computer system to: apply a set of public tags to the set of calendar events according to the set of filters; and generate a calendar view based on the set of public tags.

A fourth aspect of the present invention provides a method for deploying an application for customizing calendar views, comprising: providing a computer infrastructure being operable to: apply a set of public tags to the set of calendar events according to the set of filters; and generate a calendar view based on the set of public tags.

A fifth aspect of the present invention provides a data processing system for customizing calendar views, comprising: a memory medium having instructions; a bus coupled to the memory medium; and a processor coupled to the bus that when executing the instructions causes the data processing system to: apply a set of public tags to the set of calendar events according to the set of filters; and generate a calendar view based on the set of public tags.

Aspects of the present invention can also provide one or more of the following: generating a set of filters for applying the set of public tags to a set of calendar events; applying the set of public tags to the set of events using the set of filters; the set of filters being generated via a graphical user interface applying a public tag to an incoming calendar event; applying a public tag to an outgoing calendar event; the set of public tags being viewable by all views and all recipients of invitations to the set of events.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a simple possible filter for tagging calendar events according to an embodiment of the present invention.

FIG. 2 depicts a normal calendar view with user-created tags shown on top according to an embodiment of the present invention.

FIG. 3 depicts a calendar view with two tags selected according to an embodiment of the present invention.

FIG. 4 depicts a user interface allowing a more flexible combination of tags.

FIG. 5 depicts a more specific computerized implementation according to an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

For convenience, the Detailed Description of the Invention has the following Sections:

I. General Description

II. Computerized Implementation

### I. General Description

As indicated above, the present solution provides a system for users to create custom tags, apply them to calendar events, and then view calendar events based on various combinations of tags. Users can manually apply either preexisting or newly created tags (public and/or personal) to individual (or repeating) calendar events or they can create filters to automatically apply tags to meetings. Filters may used to apply personal (or public) tags to events in an individual's personal calendar, or they may be used to apply public system-wide tags to calendar events being sent to a list of participants. Filters can be created to apply tags to a meetings based on a various attributes of the meeting, such as keywords in either the subject or meeting text, the meeting chair, the number of attendees, whether or not the user is required to attend, etc. For example, a user might create a filter to tag all of the meetings pertaining to a particular project by identifying certain keywords, or might tag all the meetings that are held off site and require a dial in. Additionally, some events can be tagged by the meeting chair with certain system-wide public tags. For example, technology demos might be marked as such by their authors so that individual users would not all need to tag the meetings. Filters can be applied to all new calendar events, but they can also be applied retroactively to all existing calendar events; in this way filters can function as an extensible search tool through the calendar.

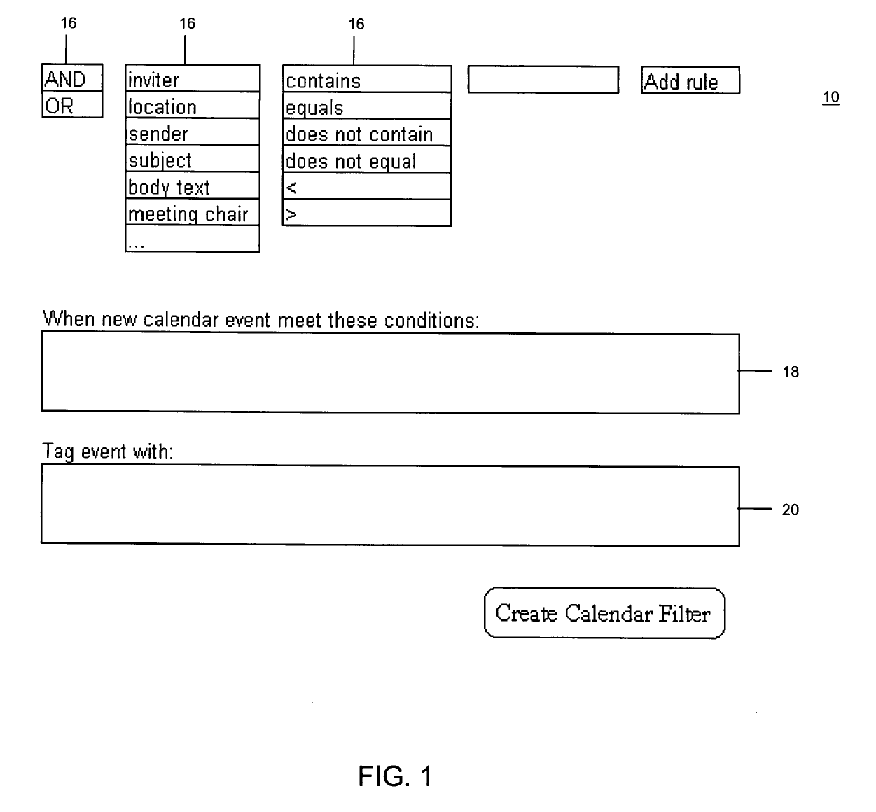

Referring now to FIG. 1, an example of a graphical user interface for creating filters to tag calendar events. A user can create a filter based on one or more conditions and tag an event with one or more tags. The conditions can be based on various elements such as whether or not the sender equals a certain value or whether or not the body of the invite contains a certain string. Specifically, a user can select certain characteristics, inclusion requirements and Boolean operators 16 that will operate as conditions. Such conditions will be populated into condition field 18. The user can also specify a tag via tag field 20 that will be applied to an event meeting the conditions of condition field 18.

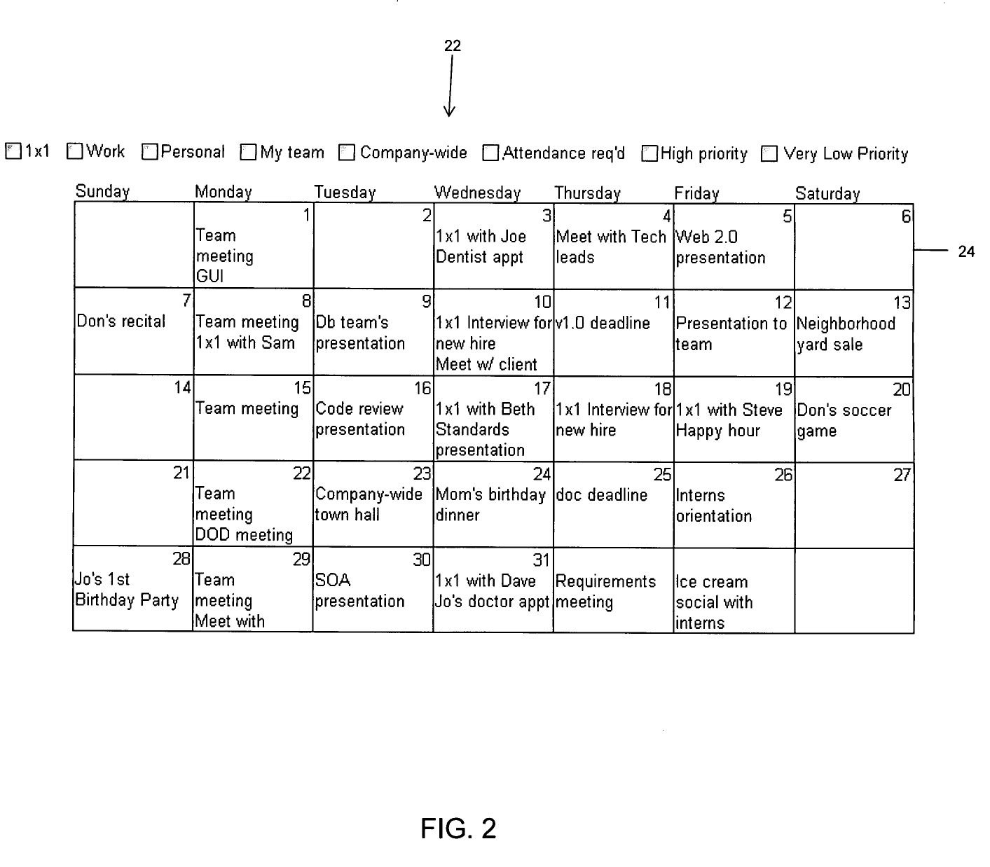

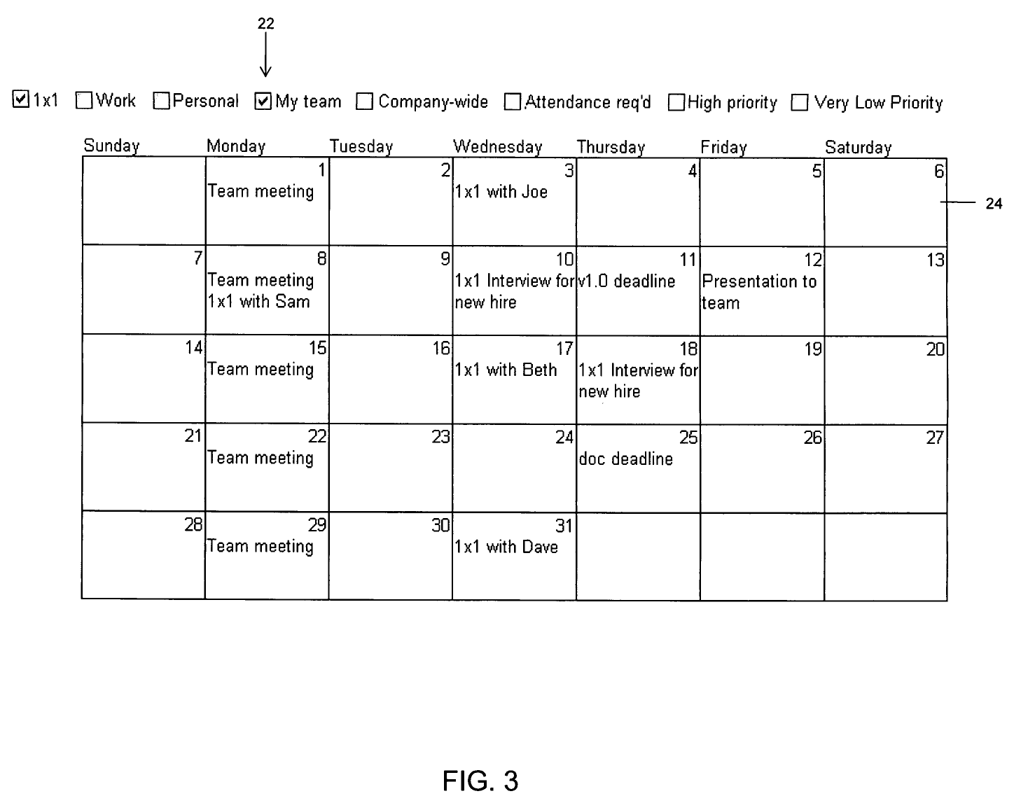

A user can filter their calendar view based on combinations of tags. For example, a calendar view interface could list all of the user's tags—checking off individual tags would cause events marked with that tag to be displayed. FIG. 2 below shows an example of a possible calendar view interface with tags 22 listed above calendar 24. FIG. 3 shows the same interface with two tags selected (e.g., “1x1” and “my team”) and the resulting calendar view. Only events that have been tagged with the selected tags 22 will be displayed in calendar 24. Not all of the user-created tags need to be displayed above the calendar. A user may have 30 different tags, but only desire for a few tags to be displayed. Calendar software can easily store a list of all tags and a list of the tags a user wants to display, as well as provide a user interface for choosing what tags to display.

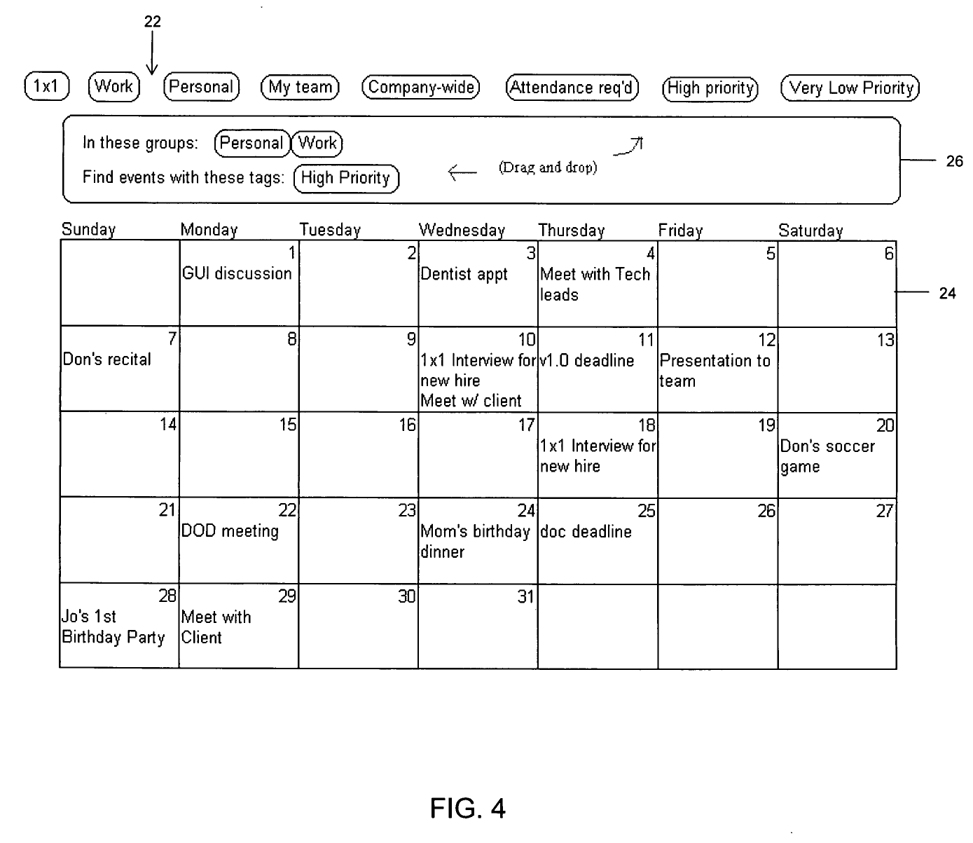

A more complex interface might allow users to filter for events that have various combinations of tags; for example the user might be interested in all events that involve either the project X or project Y, but only those also marked as high priority. FIG. 4 shows an example of a more complex interface. As shown, a user could select a combination of tags by leveraging (e.g., via drag and drop) tag combination field 26. Only events having the designated combination of tags applied thereto will be displayed in calendar 24. An even more complicated interface might allow a user to display any possible combination of tags, such as events that contain both tags A and B or tag C. (For example, a user may display “high priority” “work” events and all “personal” events.) However an interface allowing any possible combination may look more complicated than is useful.

As can be seen, the present invention not only allows tags to be generated and/or customized, but also to be applied system-wide or publicly. That is, the tags can be viewed and/or used at least by all invitees and senders of calendar invitations.

### II. Computerized Implementation

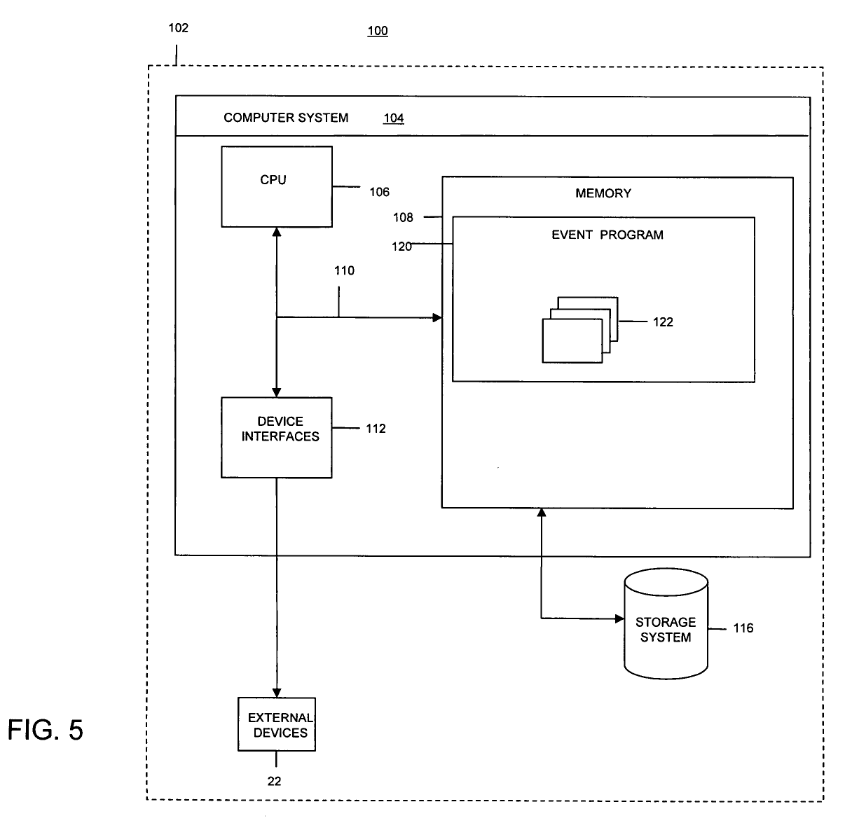

Referring now to FIG. 5, a computerized implementation 100 of an embodiment of the present invention is shown. As depicted, implementation 100 includes computer system 104 deployed within a computer infrastructure 102. Computer system 104 is intended to represent the broker as described above. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer infrastructure 102 is intended to demonstrate that some or all of the components of implementation 100 could be deployed, managed, serviced, etc., by a service provider who offers to implement, deploy, and/or perform the functions of the present invention for others. In addition, although computer infrastructure 102 is depicted as a single computer system, this need not be the case, rather computer infrastructure 102 could be implemented as multiple computer systems.

As shown, computer system 104 includes a processing unit 106, a memory 108, a bus 110, and device interfaces 112. Further, computer system 104 is shown external devices 114 and storage system 116 that communicate with bus via device interfaces. In general, processing unit 106 executes computer program code, such as event program 120, which are stored in memory 108 and/or storage system 116. While executing computer program code, processing unit 106 can read and/or write data to/from memory 108, storage system 116, and/or device interfaces 112. Bus 110 provides a communication link between each of the components in computer system 104. Although not shown, computer system 104 could also include I/O interfaces that communicate with: one or more external devices such as a cash broker, a keyboard, a pointing device, a display, etc.; one or more devices that enable a user to interact with computer system 104; and/or any devices (e.g., network card, modem, etc.) that enable computer system 104 to communicate with one or more other computing devices.

Computer infrastructure 102 is only illustrative of various types of computer infrastructures for implementing the invention. For example, in one embodiment, computer infrastructure 102 comprises two or more computing devices (e.g., a server cluster) that communicate over a network to perform the various process of the invention. Moreover, computer system 104 is only representative of various possible computer systems that can include numerous combinations of hardware. To this extent, in other embodiments, computer system 104 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 106 may comprise a single processing unit, or be distributed across one or more processing units in one or more locations, e.g., on a client and server. Similarly, memory 108 and/or storage system 116 can comprise any combination of various types of data storage and/or transmission media that reside at one or more physical locations. Further, device interfaces 112 can comprise any module for exchanging information with one or more external device 114. Still further, it is understood that one or more additional components (e.g., system software, math co-processing unit, etc.) not shown in FIG. 5 can be included in computer system 104.

Storage system 116 can be any type of system capable of providing storage for information under the present invention. To this extent, storage system 116 could include one or more storage devices, such as a magnetic disk drive or an optical disk drive. In another embodiment, storage system 116 includes data distributed across, for example, a local area network (LAN), wide area network (WAN) or a storage area network (SAN) (not shown). In addition, although not shown, additional components, such as cache memory, communication systems, system software, etc., may be incorporated into computer system 104.

Shown in memory 108 of computer system 104 is event program 120, which includes a set (at least one) of modules 122. The modules generally provide the functions of the present invention as described herein. For example (among other things), set of modules 122 is configured to provide and/or enable the following: applying a set of public and/or personal tags to the set of calendar events according to the set of filters; and generate a calendar view based on the set of public and/or personal tags; generating a set of filters for applying the set of public and/or personal tags to a set of calendar events; applying the set of public and/or personal tags to the set of events using the set of filters; the set of filters being generated via a graphical user interface applying a public and/or personal tag to an incoming calendar event; applying a public tag to an outgoing calendar event; the set of public tags being viewable by all views and all recipients of invitations to the set of events.

While shown and described herein as a solution for customizing calendar events, it is understood that the invention further provides various alternative embodiments. For example, in one embodiment, the invention provides a computer-readable/useable medium that includes computer program code to enable a computer infrastructure to provide mobile web service brokering. To this extent, the computer-readable/useable medium includes program code that implements each of the various process of the invention. It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 108 (FIG. 5) and/or storage system 116 (FIG. 5) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process of the invention on a subscription, advertising, and/or fee basis. That is, a service provider, such as a Solution Integrator, could offer to provide customization calendar events. In this case, the service provider can create, maintain, and support, etc., a computer infrastructure, such as computer infrastructure 102 (FIG. 5) that performs the process of the invention for one or more customers. In return, the service provider can receive payment from the customer(s) under a subscription and/or fee agreement and/or the service provider can receive payment from the sale of advertising content to one or more third parties.

In still another embodiment, the invention provides a computer-implemented method for customizing calendar events. In this case, a computer infrastructure, such as computer infrastructure 102 (FIG. 5), can be provided and one or more systems for performing the process of the invention can be obtained (e.g., created, purchased, used, modified, etc.) and deployed to the computer infrastructure. To this extent, the deployment of a system can comprise one or more of: (1) installing program code on a computing device, such as computer system 104 (FIG. 5), from a computer-readable medium; (2) adding one or more computing devices to the computer infrastructure; and (3) incorporating and/or modifying one or more existing systems of the computer infrastructure to enable the computer infrastructure to perform the process of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic device system/driver for a particular computing and/or processing device, and the like.

A data processing system suitable for storing and/or executing program code can be provided hereunder and can include at least one processor communicatively coupled, directly or indirectly, to memory element(s) through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output or device devices (including, but not limited to, keyboards, displays, pointing devices, etc.) can be coupled to the system either directly or through intervening device controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems and Ethernet cards.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A method for customizing calendar views, comprising:
applying a set of public tags to a set of calendar events according to a set of filters; and
generating a calendar view based on the set of public tags.

2. The method of claim 1, further comprising generating a set of filters for applying the set of public tags to the set of calendar events;

3. The method of claim 2, further comprising, applying the set of public tags to the set of calendar events using the set of filters.

4. The method of claim 2, the set of filters being generated via a graphical user interface.

5. The method of claim 1, the applying comprising applying a public tag to an incoming calendar event.

6. The method of claim 1, the applying comprising applying a public tag to an outgoing calendar event.

7. The method of claim 1, the set of public tags being viewable by all views and all recipients of invitations to the set of events.

8. A system for customizing calendar views, comprising:
a module for applying a set of public tags to a set of calendar events according to a set of filters; and
a module for generating a calendar view based on the set of public tags.

9. The system of claim 8, further comprising a module for generating a set of filters for applying the set of public tags to a set of calendar events.

10. The system of claim 9, further comprising a module for applying the set of public tags to the set of calendar events using the set of filters.

11. The system of claim 9, the set of filters being generated via a graphical user interface.

12. The system of claim 8, the applying comprising a module for applying a public tag to an incoming calendar event.

13. The system of claim 8, the applying comprising a module for applying a public tag to an outgoing calendar event.

14. The system of claim 8, the set of public tags being viewable by all views and all recipients of invitations to the set of events.

15. A program product stored on a computer readable medium for customizing calendar views, the computer readable medium comprising program code for causing a computer system to:
apply a set of public tags to a set of calendar events according to a set of filters; and
generate a calendar view based on the set of public tags.

16. The program product of claim 15, the computer readable medium further comprising program code for causing the computer system to generate a set of filters for applying the set of public tags to a set of calendar events.

17. The program product of claim 16, the computer readable medium further comprising program code for causing the computer system to apply the set of public tags to the set of events using the set of filters.

18. The program product of claim 16, the set of filters being generated via a graphical user interface.

19. The program product of claim 15, the computer readable medium further comprising program code for causing the computer system to apply a public tag to an incoming calendar event.

20. The program product of claim 15, the computer readable medium further comprising program code for causing the computer system to apply a public tag to an outgoing calendar event.

21. The program product of claim 15, the set of public tags being viewable by all views and all recipients of invitations to the set of events.

22. A method for deploying an application for customizing calendar views, comprising:
providing a computer infrastructure being operable to:
apply a set of public tags to a set of calendar events according to a set of filters; and
generate a calendar view based on the set of public tags.
